(19) United States
(12) Patent Application Publication
(10) Pub. No.: US 2016/0021703 A1
(43) Pub. Date: Jan. 21, 2016

(54) HEATING APPLIANCE

(71) Applicant: BASIC HOLDINGS, Cloghran, Co. Dublin (IE)

(72) Inventor: Alan McDonald, Lisburn Antrim (GB)

(73) Assignee: Basic Holdings, Cloghran, Co. Dublin (IE)

(21) Appl. No.: 14/773,105

(22) PCT Filed: Mar. 6, 2014
(86) PCT No.: PCT/EP2014/054404

§ 371 Date: Sep. 4, 2015

(30) Foreign Application Priority Data
Mar. 6, 2013 (GB) 1304025.8

(51) Int. Cl. H05B 1/02; G05B 15/02

(52) U.S. Cl. CPC H05B 1/0275; G05B 15/02

(57) ABSTRACT

Provided is an electronic display panel for installation on devices subject to temperature fluctuations, the panel comprising a controller configured to deactivate the display panel when the temperature of the display panel is outside a preferred operational temperature range of the display panel.

### FIELD

The present teaching relates to heating appliances and in particular to displays for heating appliances. Within the context of the present teaching a heating appliance includes space heaters of the type used for supplying heat to a building. It also includes heating appliances used for providing heat for cooking such as ovens, cookers and the like. Being heating appliances or heating devices they are subject to temperature fluctuations during operation and the present teaching particularly relates to displays used in the control or operation of such devices. In one preferred implementation the present teaching relates to a heating appliance comprising a Liquid Crystal Display (LCD) panel.

### BACKGROUND ART

Heating appliances that are used for supplying heat to a building are well known and vary from those used as part of a central heating system such as radiators, underfloor heating systems and the like to stand alone appliances such as storage heaters, fan heaters etc. In the context of this latter variety of appliances it is known to provide integrated controls such as control knobs, indicator lights and the like. These are typically located on the housing of the heating appliance and located so as to be easily accessible to a user who desires to change the operating characteristics of the heating appliance. Conventionally these are mechanical in nature having one or more moveable parts which are used to effect changes in the operation of the heating appliance.

While different in application, another category of heating appliance, the oven or cooker, is also known to incorporate to provide integrated controls such as control knobs, indicator lights and the like. These are again typically located on the housing of the cooker or oven and located so as to be easily accessible to a user who desires to change the operating characteristics of the heating appliance. Again, conventionally these are mechanical in nature having one or more moveable parts which are used to effect changes in the operation of the heating appliance.

Within this overall context of operational controls or displays there is a move generally away from mechanical arrangements and towards electronic displays and the like. This arises from a number of reasons including a user appreciation of the additional functionality that can be provided through use of a digital electronic display. An example of such a digital display is a Liquid Crystal Display (LCD). LCDs are used in a wide range of applications, including computer monitors, televisions, instrument panels, aircraft cockpit displays, signage, etc. They are common in consumer devices such as video players, gaming devices, clocks, watches, calculators, and telephones. LCDs have replaced cathode ray tube (CRT) displays in most applications. They are available in a wider range of screen sizes than CRT and plasma displays, and since they do not use phosphors, they cannot suffer image burn-in.

Known LCD panels are typically of the reflective or transmissive types. A reflective-type LCD uses reflection to illuminate the LCD panel and its operation is dependent on the availability of external light sources. A transmissive-type LCD uses an internal light source for illumination and the internal light source is commonly referred to as backlight. An advantage of the transmissive-type LCD, which is also commonly referred to as backlit LCD, is its usefulness for outdoor operation because its backlight intensity can be adjusted according to the ambient light conditions of the outdoor environment which changes widely during different times of the day and according to weather conditions.

While it is known to use such LCDs in heating appliances such as heaters and cookers, for displaying characteristics and properties associated with the appliances, such as the desired internal temperature of an oven cavity, or the desired room temperature of a domestic heater, the location of the LCDs on the actual housing of the appliance is limited. Such appliances are subject to significant temperature variations depending on their heating mode and/or the ambient temperature. The LCD devices are typically installed to the front of the appliance in a prominent location as a user display for a user of the appliance to both view and adjust operational settings of the appliance. The LCD panel may be provided on a front surface of the heating appliance and enables control of the appliance directly while viewing the results of the control changes. The LCD devices when installed on such heating appliances may be installed on or proximate to a hot surface of the appliance.

LCDs have a storage temperature range of approximately −40 to 80 degrees depending on whether the LCDs are Twisted Nematic (TN) LCDs or Super Twisted Nematic (STN) LCDs, and have an operating temperature range of approximately −20 to 70 degrees. The storage temperature refers to the temperature of the LCD in a powered-off mode. The operating temperature refers to the temperature of the LCD in a powered-on mode. As can be seen from the above, the operating temperature range is within the storage temperature range. A problem with using LCDs in high temperature environments such as in combination with heating appliances is that the operating temperature range of the heating appliance is greater than the desired operating range of the LCD panel. As a result the contrast of the LCD display deteriorates over time, thus being ineffectual as a display means. Thus, it will be appreciated that the performance of LCD user displays is significantly affected by the temperature environment in which they are disposed.

In heating appliances such as storage heaters which can have operating core temperatures of up to 750 degrees, LCD panels therefore have to be thermally insulated from the heat source in order to maintain performance. The heating elements inside the heating appliances cause the ambient air temperature inside the appliance to rise above the operating temperature range of the LCD panel, thus causing the LCD panel to malfunction. In some arrangements, the ambient air temperature inside the appliance may be reduced by transferring heat in the ambient air through the heating appliance to a heat sink and to the atmosphere using forced or natural convection. This requires extra insulating components and materials, and may occupy more space, thereby increasing manufacturing and installation costs. Further, a significant amount of time is required for cooling LCD panels.

For these reasons and others, there is a need for an improved arrangement whereby heating appliances can include display panels such as LCDs without fear of the display panel performance deteriorating during usage as a result of temperature fluctuations.

### SUMMARY

These and other problems are addressed by heating appliance comprising a display panel in accordance with the present teaching.

Accordingly, the present teaching provides a heating appliance as detailed in claim 1. Advantageous features are provided in dependent claims.

These and other features of the present teaching will be better understood with reference to the following drawings.

### BRIEF DESCRIPTION OF THE DRAWINGS

The present teaching will now be described with reference to the accompanying drawings in which:

FIG. 1 is a graph showing the temperature range in which an exemplary LCD panel operates and the corresponding activation/deactivation state of the LCD panel according to its temperature;

FIG. 2 illustrates a block diagram of an LCD panel according to an embodiment of the present teaching;

FIG. 3 illustrates the structure of an LCD panel according to an embodiment of the present teaching;

FIG. 4 illustrates an LCD panel installed on the front of a domestic heating appliance in the form of a typical storage heater.

### DETAILED DESCRIPTION OF THE DRAWINGS

Exemplary arrangements of a heating appliance incorporating an exemplary LCD panel provided in accordance with the present teaching will be described hereinafter to assist with an understanding of the benefits of the present teaching. Such an LCD panel will be understood as being exemplary of the type of LCD or other electronic display that could be provided and is not intended to limit the present teaching to any one specific arrangement as modifications could be made to that described herein without departing from the scope of the present teaching.

The present inventors have realised that an electronic display panel installed on devices subject to temperature fluctuations does not need to be activated at times when the temperature of the panel is outside its optimal operating temperature range. Accordingly, the present teaching provides an arrangement whereby the display panel is coupled to a controller configured to deactivate the panel when the temperature of the panel is outside a temperature range of the panel. The panel may be suitably installed on a heating appliance comprising a heating element. The panel is configured to be deactivated when the temperature of the panel is greater than a first predetermined temperature and less than a second predetermined temperature. The first and second predetermined temperatures are typically the lower and upper limits of the operating temperature range of the panel. As will be appreciated, when the heating appliance is in a heating mode, the heating element may cause the heating appliance to be heated to temperatures that are above the recommended operating temperature range of the panel. The panel may be thermally insulated from the heating element in the heating appliance, but it will be appreciated that such insulation may not be very effective. Thus, despite such thermal insulation, the panel may be heated to temperatures above its operating range. The panel may accordingly be configured to be activated only at times when the temperature of the panel is within its recommended operating range.

In another embodiment, the panel may be configured to be activated only when a user is in the vicinity of the appliance on which the panel is installed. In this regard, the panel will typically be installed on the front of applicances such as domestic heating appliances, for example cookers and portable or fixed room heaters, so that the user can view the display of the panel. There is no need for the panel to be activated when the user is far away from the heating appliance to the extent that the user cannot comfortably read the display of the panel. Accordingly, the present teaching provides that the panel may be activated only when the user is close to the panel.

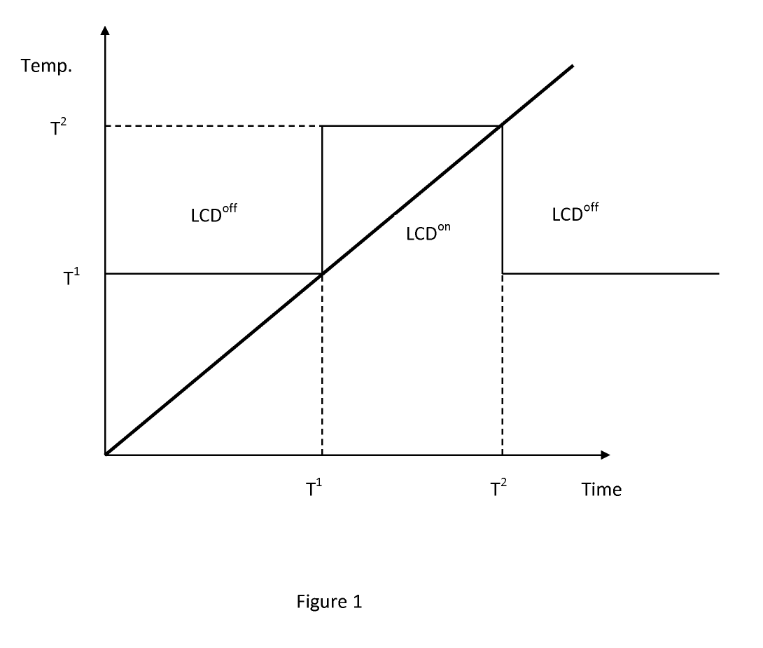

FIG. 1 is a graph showing the operating temperature range of a display panel, in this exemplary arrangement a LCD panel installed on a heating appliance comprising a heating element, and the corresponding activation/deactivation state of the LCD panel installed on the heating appliance according to its temperature.

Referring to FIG. 1, the LCD panel may be configured to be activated when the temperature of the LCD panel is within the operating temperature range of the LCD. The operating temperature of the LCD panel may be in a temperature range from T¹ to T². That is, the LCD panel may be configured to be activated when the temperature of the LCD panel is greater than or equal to the lower limit T¹ of the LCD operating temperature range and less than or equal to the upper limit T² of the LCD operating temperature range. The lower and upper limits T¹ and T² may correspond to the recommended operating temperature range of the LCD as provided by the LCD manufacturer. Alternatively, the lower and upper limits T¹ and T² may be set by the user or installer according to the environment in which the LCD panel is being used. This higher temperature may correspond with expected temperatures associated with misuse of the heater—such as for example when the heater is covered.

The user may set the lower and upper limits T¹ and T² to optimise the display, for example in a range within or around the recommended operating range. When the temperature of the LCD panel is outside the operating temperature range of the LCD, the LCD panel is configured to be deactivated. It will thus be appreciated that the LCD panel is configured to be activated and deactivated at specific temperatures corresponding to upper and lower limits of the LCD operating temperature range. Thus, it may be ensured that the LCD panel will be operational only within its recommended temperature range. Accordingly a binary-type configuration is provided whereby the LCD panel is either activated or deactivated, and no intermediate operating mode is effected. This provides the advantage that an optimal display is provided for the user when the LCD panel is operational, and not an unsatisfactory display at temperatures close to the lower and upper limits of the LCD operating temperature.

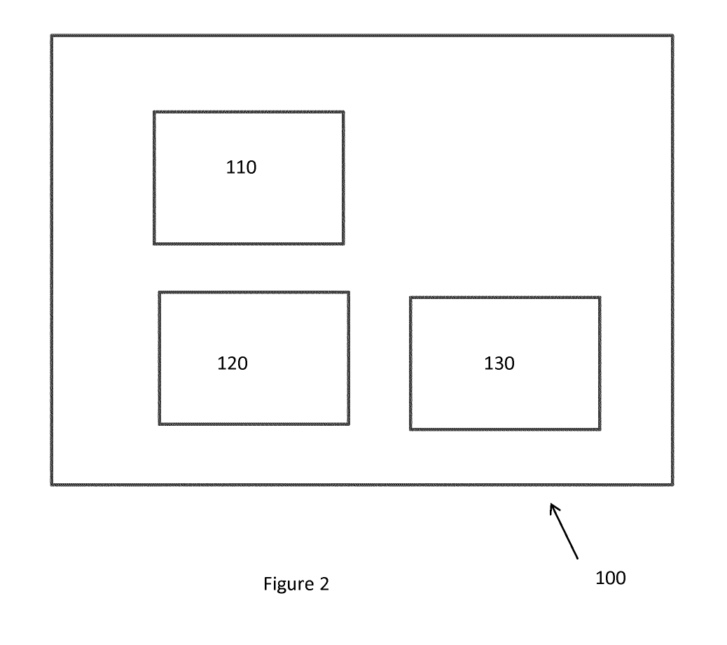

FIG. 2 illustrates a block diagram of an LCD panel 100 according to an embodiment of the present teaching. Referring to FIG. 2, the LCD panel 100 according to the present embodiment comprises a controller 110, a temperature sensor 120, and a proximity sensor 130. The temperature sensor 120 may sense the temperature of the LCD panel 100, and the controller 130 may control the operation of the LCD panel 100 according to the sensed temperature. The controller 110 may comprise a microprocessor. For example, the temperature sensor 120 may be connected to a microprocessor which controls a switch to operate the LCD. The temperature sensor 120 may provide temperature data to the microprocessor. The microprocessor may include logic to operate the LCD within a desired operating temperature range. When the controller 110 detects that that the temperature sensed by the temperature sensor 120 is within the operating temperature range of the LCD panel 100, the controller 110 may activate the LCD panel 100. When the controller 110 detects that the temperature sensed by the temperature sensor 120 is outside the operating temperature range of the LCD panel 100, the controller 110 may deactivate the LCD panel 100. In one embodiment, the temperature sensor 120 may comprise a thermistor. As mentioned above, the controller 110 may be configured to adjust the upper and lower limits of the LCD operating temperature range. In another arrangement, the LCD panel may comprise a temperature-controlled switch configured to trip, thereby disabling the LCD panel, upon detection of a temperature outside the temperature range.

The LCD panel 100 may further comprise a proximity sensor 130 for sensing the presence of a user approaching an applicance on which the LCD panel is installed. The proximity sensor 130 may sense the proximity of a user in the vicinity of the LCD panel 100, and the controller 110 may control the operation of the LCD panel according to the sensed proximity. In this regard, the LCD panel 100 may be configured to be activated when the controller 110 detects a user presence sensed by the proximity sensor 130. It will be appreciated that the LCD panel is not required to be in an activated mode when the user is not present. Thus, when the user approaches an appliance on which the LCD panel is installed, the proximity sensor 130 may sense the presence of the user and the controller 130 may control the operation of the LCD panel to be activated according to the detected presence. Similarly, when the user moves away from the appliance, the LCD panel 100 may be controlled by the controller 110 to be deactivated. The proximity sensor 130 may be disposed on a front portion of the LCD panel 100, and may be disposed on an outer surface of the LCD panel 100.

The operation of the LCD panel 100 may be controlled by the controller 110 in conjunction with the temperature sensor 120 alone or in conjunction with the temperature sensor 120 and the proximity sensor 130. That is, the operation of the LCD panel 100 may be controlled by the controller 110 according to the temperature of the LCD panel 100 alone, or according to the temperature and the presence of a user.

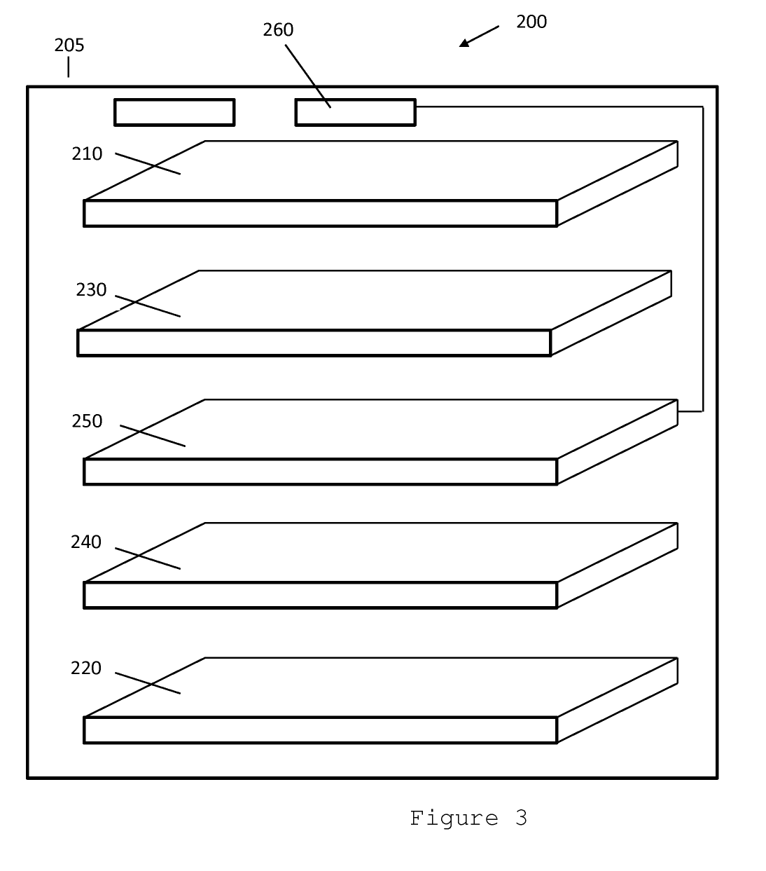

FIG. 3 illustrates the structure of an LCD panel 200 according to an embodiment of the present teaching. Referring to FIG. 3, the LCD panel 200 may include a housing 205 for accommodating front and rear transparent substrates 210 and 220, polarizing layers 230 and 240 adjacent to the substrates 210 and 220, and a liquid crystal layer 250 between the polarizing layers 230 and 240. The LCD panel also typically includes a backlight and a power supply, which are not shown. Other internal components 260 of the LCD panel such as the controller, temperature sensor, and/or temperature-controlled switch may be disposed inside the housing 205. The internal components 260 may be disposed on one of the substrates 210 or 220. The temperature sensor may be in contact with the liquid crystal layer 250. The proximity sensor 130 may be disposed on an outer surface of a front portion of the LCD panel. In this regard, the proximity sensor 130 may be disposed on an outer surface of the housing 205 for optimal effect.

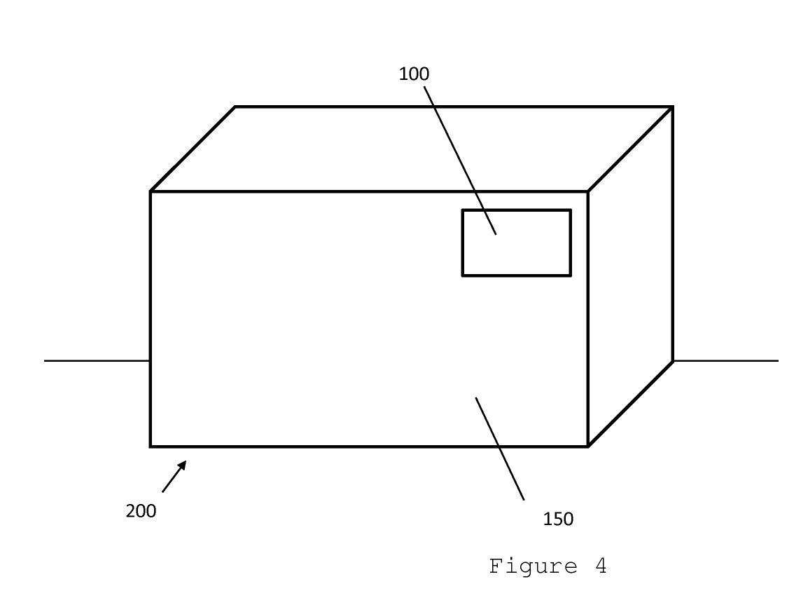

The LCD panel according to the present teaching may be utilised in heating appliances such as domestic heating appliances. One such example is a storage heater. FIG. 4 illustrates an LCD panel 100 installed on the front 150 of a typical storage heater 200. In this configuration the panel is provided in an upper region of the heater—and could be provided on the top surface. Storage heaters are well known and generally comprise a core consisting of a heat storage medium (“bricks”) in an insulated casing. Heating elements are disposed in the midst of the bricks to heat the bricks. Generally the storage heaters are locally controlled so that the heating elements are switched on during a time when the supply of electricity is cheaper (the “off-peak” time), which is usually overnight. The time of activation of the heating elements may be coincident with an advertised time provided by the network operator. The display panel is mounted proximal to the heating elements that are provided by the storage medium and experiences heat arising both from conduction through the housing and also radiation as the heat rises.

During the off-peak period the bricks are heated by the heating elements, typically to a temperature of about 650 C so that heat is stored in the bricks. The insulation ensures that the rate of heat loss from the bricks is reduced to a desired level. During the day, when electricity is more expensive, the heating elements are turned off and heat from the heat storage bricks is radiated into the room to heat the room. The amount of insulation affects the rate of heat loss from the core into the room. This method of heating is advantageous in that it is relatively simple and inexpensive to install, clean in use and relatively cheap to run. However, there are a number of disadvantages.

For example, because heat is stored in the bricks during the off-peak (overnight) period, the core reaches its highest temperature in the early morning, normally at about 7.00 am. Consequently, the heat output from the storage heater is greatest at this time. This is not ideal since most people are more active in the early morning (preparing to go out to work or school, etc.) and so less heat is required. After reaching its maximum temperature in the morning, heat is lost from the core during the day. The heat output decays approximately exponentially so that by the evening-before the core is recharged with heat, the heat output can be quite low.

Storage heaters usually have two controls—a charge control (often called “input”), which controls the amount of heat stored, and the draught control (often called “output”), which controls the rate at which heat is released. These controls may be controlled by the user, or may operate automatically once the user selects the target room temperature on a thermostat. Such a storage heater as described above may be equipped with an LCD panel for displaying various characteristics of the storage heater such as the input and output settings.

The storage heater stores thermal energy in a first period, generally the night time, and releases the stored energy in a second period, generally the day time. During this period, the temperature of the storage heater in the heat storage mode may reach temperatures of up to 750 degrees. An LCD panel installed on such a storage heater may be heated accordingly. While the LCD panel may be thermally insulated to an extent from the heating element, the LCD panel may still heat up to a temperature greater than its operating temperature range. As such, the temperature of the LCD panel during the heat storage mode may adversely affect the display of the LCD panel in terms of the contrast of the display, rendering the display as unreadable. During the day when the heat is released, the temperature of the storage heater is much less and thus the temperature of the LCD panel may be within its operating range and the display of the LCD panel may be readable. In addition, at night time, there is typically no need to have the LCD panel in an activated mode as the user will typically not be present.

An LCD panel according to the present teaching installed on such a storage heater may be configured to be deactivated in the heat storing mode of the storage heater. The LCD panel may be configured to be activated in the heat releasing mode of the heating appliance. The LCD panel may be deactivated when the temperature of the LCD panel is greater than the operating temperature range of the LCD panel. Thus, problems such as loss of contrast if the temperature of the LCD panel is greater than the operating temperature of the LCD panel are rendered moot by the deactivation of the LCD panel. The LCD panel may be activated when the temperature of the LCD panel is within the operating temperature range of the LCD panel. The LCD panel may be further controlled to be activated when a user is in the vicinity of the storage heater by incorporating a proximity sensor as described above. It will be understood that the user may generally be in the vicinity of the storage heater during the day or evening. During the night time, the user is generally not in the vicinity of the storage heater, and thus the LCD panel of the present teaching may be configured to be deactivated during this time.

Another application may be a cooking appliance such as a common cooker comprising four hobs, a grill and an oven. An electronic display panel, such as a LCD panel, according to the present teaching may be installed on a front portion of the cooker and may be configured to be deactivated in a cooking mode when, for example, a door of the oven or grill is opened and the LCD panel is exposed to the resultant heat. It will be appreciated that when a door of the cooker is opened, the user will not be concerned with viewing and/or adjusting settings on the LCD panel. Thus, there may not be a requirement for the LCD panel to be in an activated mode in this situation. The present teaching obviates the necessity to have the LCD panel in a constant activated mode in situations where it is not necessary to interact with the LCD panel.

Other heating appliances on which the LCD panel according to the present teaching may be used include microwave ovens, immersion heaters and the like. In an immersion heater, water is heated within a hot water cylinder using an immersion heating element. Such heating of the water is desirably to a set-point, typically about 60° C. to address potential issues regarding contamination by legionella bacteria. Domestic water cylinders are typically about 150 litres capacity and being well insulated can be heated at any time during the day in the anticipation that unless water is drawn from the cylinder such heat will remain in the cylinder until required. Availing of off-peak demand it is known to provide such heating through activation of an electrical resistance heater such as an electrical coil that forms part of the immersion heater during the off-peak periods. The present inventors have realised that the LCD panel according to the present teaching can be utilised on such an immersion heater. During the off-peak periods when the electrical coil is activated to heat the water, the LCD panel may be heated to a temperature greater than its operating temperature. The LCD panel may be deactivated at such times.

Other applications where the electronic display panel according to the present teaching may be utilised include other heating appliances other than the examples of a storage heater cooker and immersion heater provided above. Examples may include microwave ovens, electric fires, fan heaters, and gas heaters.

In addition, the electronic display panel according to the present teaching may be used on devices used in outdoor environments such as display devices and signs. In such environments the temperature may fluctuate around the lower limit of the operating temperature range. Accordingly it may be advantageous to configure the panel to be deactivated when the temperature dips below the lower limit of the operating temperature range.

It will also be understood by the skilled person that the electronic display panel according to the present teaching may be utilised on domestic cooling appliances such as refrigerators, freezers, and the like where the operating temperature thereof may be less than the operating temperature range of the panel. A display panel on a freezer may be configured to control settings such as the temperature, ice and water status, and different compartments in the freezer. The panel may be installed on a front prominent portion of the freezer. For example, the panel may be installed on the doors of the freezer. When the doors of the freezer are opened the panel may be configured to be deactivated.

The electronic display panel according to the present teaching may comprise an active matrix or passive matrix LCD, and may be a Twisted Nematic (TN) LCD or Super Twisted Nematic (STN) LCD. As mentioned above, the operating temperature range of the LCD panel may be approximately −20 to 70 degrees. Indeed it will be appreciated that LCD technology is one example of a display panel technology that can be damaged through exposure to excessive heat and other display technologies could also be used within the context of the present teaching.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present teaching. Those with skill in the art will readily appreciate that the present teachinf may be implemented in a very wide variety of embodiments. This application is intended to cover any adaptations or variations of the embodiments discussed herein. Therefore, it is manifestly intended that the present teaching be limited only by the claims and the equivalents thereof.

The words comprises/comprising when used in this specification are to specify the presence of stated features, integers, steps or components but does not preclude the presence or addition of one or more other features, integers, steps, components or groups thereof.

1. A space heater electric heating appliance configured for supplying heat to a building, the heating appliance comprising:
a housing at least partially enclosing a heating element, the heating element having an operating mode during which heat is emitted from the heating element;
an electronic display panel on an outer surface of the housing, the display panel operably providing a visual indicator of the operating conditions of the heating appliance, the display panel being coupled to a controller, the controller being configured to selectively deactivate the display panel during selective periods of the operating mode when the heat emitted by the heating element results in the display panel being heated outside a predetermined temperature range.

2. The heating appliance of claim 1, comprising a temperature sensor, the controller being coupled to each of the temperature sensor and the electronic display panel and configured to deactivate the panel when a sensed temperature from the temperature sensor indicates the actual temperature of the panel is outside the predetermined temperature range.

3. The heating appliance of claim 2, wherein the controller is operable to deactivate the panel when the sensed temperature of the panel is greater than the predetermined temperature range of the panel.

4. The heating appliance of claim 2, wherein the controller is operable to deactivate the panel when the sensed temperature of the panel is less than the predetermined temperature range of the panel.

5. The heating appliance of claim 1, wherein the controller is operable activate the panel when a sensed temperature of the panel is within the predetermined temperature range of the panel.

6. The heating appliance of claim 2, wherein the temperature sensor comprises a thermistor.

7. The heating appliance of claim 2, comprising a temperature-controlled switch configured to trip, thereby deactivating the panel, upon detection of a temperature outside the predetermined temperature range.

8. The heating appliance of claim 1, further comprising a proximity sensor for detecting a user presence in the vicinity of the heating appliance.

9. The heating appliance of claim 8, wherein the controller is operable to activate the panel when the proximity sensor detects a user presence.

10. The heating appliance of claim 9 wherein the controller is operable to activate the panel when the proximity sensor detects a user presence and a sensed temperature of the panel is within a predetermined temperature range.

11. The heating appliance of claim 9, wherein the controller is operable to deactivate the panel when the proximity sensor does not detect a user presence.

12. The heating appliance of claim 2, wherein the controller is configurable to adjust the predetermined temperature range.

13. The heating appliance of claim 1, wherein the controller comprises a microprocessor.

14. The heating appliance of claim 2, wherein the predetermined temperature range comprises an operating temperature range of the panel.

15. The heating appliance of claim 1, wherein internal components of the panel are disposed within the housing.

16. The heating appliance of claim 1, wherein the display panel comprises a liquid crystal layer.

17. The heating appliance of claim 16, wherein a temperature sensor is connected to the liquid crystal layer.

18. The heating appliance of claim 1, wherein said heating appliance is a domestic heating appliance.

19. The heating appliance of claim 18, having a first operating mode and a second operating mode.

20. The heating appliance of claim 19, having a heat storing mode and a heat releasing mode.

21. The heating appliance of claim 1, wherein said heating appliance is a storage heater.

22. The heating appliance of claim 1, wherein the display panel is mounted on the housing above the heating element.

23. The heating appliance of claim 1, wherein the housing comprises side walls and a top surface, the display panel being provided in, or on, the top surface.

24. (canceled)

25. The heating appliance of claim 1, wherein the panel is thermally insulated from the heating element.

26. The heating appliance of claim 1, wherein the panel is a LCD panel.

27. The heating appliance of claim 1, wherein the panel is a Twisted Nematic (TN) LCD.

28. The heating appliance of claim 1, wherein the panel is a Super Twisted Nematic (STN) LCD.
